(19) United States
(12) Patent Application Publication
(10) Pub. No.: US 2023/0220526 A1
(43) Pub. Date: Jul. 13, 2023

(54) Steel Material for Forming Components Using Additive Manufacturing and Use of a Steel Material of This Type

(71) Applicants: Deutsche Edetstahlwerke Specialty Steel GmbH & Co. KG, Witten (DE); Dörrenberg Edelstahl GmbH, Engelskirchen-Ründeroth (DE)

(72) Inventors: Johannes Boes, Dorsten (DE); Arne Röttger, Schwerte (DE); Werner Theisen, Hattingen (DE); Christoph Escher, Bergisch Gladbach (DE); Christian Mutke, Düsseldorf (DE); Horst Hill, Grefrath (DE); Philipp Kluge, Duisburg (DE)

(21) Appl. No.: 18/007,565

(22) PCT Filed: Jun. 2, 2021
(86) PCT No.: PCT/EP2021/064837

§ 371 Date: Dec. 1, 2022

(30) Foreign Application Priority Data
Jun. 5, 2020 (DE) 10 2020 115 049.0

(51) Int. Cl. C22C 38/04; B23K 26/342; B23K 9/04; B22F 10/28; C22C 33/02; C22C 38/00; C22C 38/02; C22C 38/44; C22C 38/46; C22C 38/48; C22C 38/50; C22C 38/52; C22C 38/58

(52) U.S. Cl. CPC C22C 38/04; B23K 26/342; B23K 9/04; B22F 10/28; C22C 33/0257; C22C 38/005; C22C 38/02; C22C 38/44; C22C 38/46; C22C 38/48; C22C 38/50; C22C 38/52; C22C 38/58; B33Y 70/00

(57) ABSTRACT

The invention relates to a steel material which allows for components to be formed with low residual stress via additive manufacturing without pre- or post-heating. The steel material consists of a steel with the following composition, in wt. %: C: 0.28-0.65%, Co: <10.0, Cr: 3.5-12.5%, optionally Mo: 0.5-12.5%, wherein the sum of the content of Cr and Mo is 4-16%, the Ni equivalent Ni_eq calculated according to the formula Ni_eq [%]=30% C+% Ni+0.5% Mn from the C-content % C, the Ni-content % Ni, the Mn-content % Mn fulfills the condition (1) 10%≤Ni eq≤20%, and alongside C, optionally respectively up to 9% Mn and up to 4.5% Ni are provided to fulfill condition (1), wherein the Cr equivalent Cr_eq calculated according to the formula Cr_eq [mass]=% Cr+% Mo+1.5% S+0.5% Nb+2% XX from the CR-content Cr %, the Mo-content Mo %, the Si-content Si %, the Nb-content % Nb and the sum % XX of the contents of at least one element of the group “Sc, Y, Ti, Zr, Hf, V, Ta” fulfills the condition (2) 4% Cr_eq 16%, and optionally respectively up to 2% Si, up to 2% Nb or at least one element from the group “Sc, Y, Ti, Zr, Hf, V, Ta” are provided to fulfill condition (2), wherein the total proportion of elements of this group is at most equal to the mass fraction of 2%, which Ti must not exceed if Ti is the only element selected from the group consisting of “Sc, Y, Ti, Zr, Hf, V, Ta”, and wherein the rest of the steel consists of Fe and <0.5% impurities, including 0.025% P and 50.025% S. The steel material is suited, in particular as a powder, for LPBF or LMD methods and as wire for the WAAM method.

### CROSS-REFERENCE TO RELATED APPLICATIONS

This application is the United States national phase of International Application No. PCT/EP2021/064837 filed Jun. 2, 2021, and claims priority to German Patent Application No. 10 2020 115 049.0 filed Jun. 5, 2020, the disclosures of which are hereby incorporated by reference in their entireties.

### BACKGROUND OF THE INVENTION

### Field of the Invention

The invention relates to a steel material for forming components using additive manufacturing.

The invention also relates to the use of such a steel material for additive manufacturing.

### Description of Related Art

If, hereinafter, “%” specifications are provided for alloys or steel compositions, these respectively refer to the mass (specification in “mass”), unless explicitly mentioned otherwise.

The proportions of certain components in the structure of a steel intermediate product or of a steel component are specified in the present text in vol. %, unless explicitly mentioned otherwise.

The phases and other constituents present in the microstructure of a component produced from steel material according to the invention can be determined by means of conventional metallographic examinations or by X-ray diffraction (“XRD”), in which case the evaluation of the microstructural proportions can be carried out according to the Rietveid method.

All of the mechanical properties of an intermediate steel product or steel part specified in this text are determined in accordance with DIN 50125, unless otherwise stated. To the extent that this text contains data on impact energy or impact strength, these are determined in accordance with DIN EN 10045.

The Vickers hardness test was performed in accordance with DIN EN ISO 6507-1:2006-3 and the Rockwell hardness test in accordance with DIN EN ISO 6508-1: 2016-12. The conversion of hardness values specified in Vickers hardness HV to hardness values specified in Rockwell HRC was performed in accordance with DIN EN ISO 18625:2014-02.

Additive manufacturing methods are, by now, applied in many industrial and application fields. The production of metal components via additive manufacturing typically takes place on the basis of a metal powder. In order to form a solid body from the powder, particles of the powder that are adjacent to one another are exposed, selectively and in a locally delimited manner, to an energy source in order to produce a solid, integrally bonded connection of adjacent particles via melting or diffusion.

The term “additive manufacturing method” here encompasses all production methods in which an additive material, which is provided for example in powder form, is added to produce a component. This addition thereby generally takes place in layers. “Additive manufacturing methods”, which are often referred to in technical jargon as “generative methods” or more generally as “3D printing”, thus contrast with the classic subtractive manufacturing methods, such as machining methods (e.g. milling, drilling and turning), in which material is removed to give the component to be manufactured its shape in each case. Likewise, additive methods differ in principle from the conventional solid shaping methods, such as forging and the like, in which the respective steel part is shaped from a starting or intermediate product while maintaining mass.

The additive manufacturing principle makes it possible to produce geometrically complex structures that cannot be realized or can only be realized at great expense using conventional manufacturing methods, such as the aforementioned machining methods or original/forming methods (casting, forging) (see VDI Status Report “Additive Fertigung”, November 2019, published by Verein Deutscher Ingenieure e.V., VDI Gesellschaft

Produktion and Logistik, DOsseldorf, Germany) Department of Production Technology and Manufacturing Processes, www.jelsatuswIaliv).

Further definitions of the methods which are encompassed under the generic term “additive methods” can be found, for example, in VDI guidelines 3404 and 3405.

The additive manufacturing methods that allow the provision of metal components of complex shape include in particular the methods known under the acronyms “L-PBF” (Laser-Powder Bed Fusion), “LMD” (Laser Metal Deposition) and “WAAM” (WAAM=Wire Arc Additive Manufacturing).

In the L-PBF method, in a first working step the material to be processed is applied as a powder in a thin layer onto a base plate and is remelted, by means of a laser moved over the powder layer, in the impingement region of the laser beam. The melt formed in this way in a locally delimited manner then solidifies to form a solid volume element of the component to be formed. In this manner, a solid material layer is successively formed which extends over the cross-sectional area and shape, respectively associated therewith, of the component to be formed. In the following step, a further powder layer is applied to the previously formed solid layer of the component, which further powder layer is solidified in the same way by means of the laser beam to form a layer attached in an integrally bonded manner to the previously formed component layer. This process is repeated until the component has been fully constructed. In practice, the component is built up with the aid of computers, taking into account

volume layer data records that can be generated with computer programs known to those skilled in the art.

In the LMD method, also called “laser deposition welding”, a laser generates a locally delimited weld pool on a surface of a component and at the same time melts the powder material introduced into the molten bath.

Here, too, the melt thus formed solidifies to form a solid portion of the component to be constructed. Material can be selectively applied in this way, and a component can be formed successively in this way.

Given the WAAM method, also called arc wire deposition welding, as in conventional arc welding a locally delimited weld pool is produced by means of a welding torch, through which weld pool a welding wire is guided; the weld pool subsequently solidifies to form a solid portion of the component to be constructed. Via a relative movement of torch and component, it is possible in this way to apply material following any contours, and thus the component to be formed cab be successively constructed.

In practice, there is a great need for tools of complex shape which meet high demands on their tribo-mechanical properties. It has therefore been attempted to utilize tool steels whose property profile meets these requirements, by means of additive manufacturing methods such as L-PBF (Laser Powder Bed Fusion) or LMD (Laser Metal Deposition), for the production of tools which are to be used for the primary shaping and reshaping of metals, ceramics, polymers, and similar. The additive manufacturing of such tools is also referred to as “Rapid Tooling” and allows the production of complex tool geometries that would not be producible in this form in conventional, subtractive manufacturing methods.

For the additive tool production, powder is currently typically resorted to which consists of maraging steels (“martensitic-agina”). An example of this type of steel is the steel standardized under DIN material number 1.2709, which consists of, all indications in wt. %, <0.03% C, <0.25% Cr, <0.15% Mn, ≤0.1% P, ≤0.1% S, ≤0.05% Si, 0.8-1.20% Ti, 4.5-5.2% Mo, 17.0-19.0% Ni, balance Fe and technically unavoidable impurities. In maraging steels, martensitic hardening is due to the lowering of the austenite-ferrite transformation temperature (“γ→α transformation”) by increased Co and Ni contents and the associated formation of a high dislocation density as a result of the transformation.

In this process, the components formed from the 1.2709 steel can be subjected to age hardening at temperatures in the range of 450° C. to 500° C. to further increase strength, during which fine strength-increasing intermetallic phases form in the metal matrix as a result of the presence of elements such as Al, Ti and Ni. At the same time, the soft-martensitic Matrix of the component is maintained. This ensures a sufficiently high toughness, so that the level of the thermally induced and conversion-induced residual stresses in the component remains so low, despite high cooling rates, that a formation of cracks is avoided.

Due to its resulting low tendency for cold crack formation, powder whose particles consist of the 1.2709 maraging steel could be qualified for the additive production of tools for plastics injection molding, for example. However, for the production of tools for metal processing and metal machining, the 1.2709 steel has proven to be only of limited usability since it has, in particular, a hardness insufficient for these applications and a limited durability at usage temperatures above 500° C.

For this reason, attempts have been made in recent years to use commercially available tool steels, which are known to have the potential for a higher hardness or temperature resistance, as a material for powder for additive manufacturing. An example of this is the hot work tool steel known as “H13”, which is standardized under DIN

material number 1.2344 and consists of, in wt. %, 0.35-0.42% C, 0.80-1.20% Si, 0.25-0.5% Mn, 0.030% P, 0.020% S, 4.80-5.50% Cr, 1.20-1.50% Mo, 0.85-1.15% V, balance Fe and other technically unavoidable impurities. Another example is M2 high-speed steel, which is standardized under DIN material number 1.3343 and consists of, in wt. %, 0.86-0.94% C, 3.80-4.50% Cr, <0.40% Mn, ≤0.030% P, ≤0.030% S, <0.45% Si, 1.70-2.0 V, balance Fe and other technically unavoidable impurities. In the “casting” state, the structure of these steels consists of a carbon-martensitic metal matrix in which the starter carbides are present as a result of a starting treatment after prior hardening.

Another example is the “M2” steel also belonging among the high-speed steels, which is also offered as a “Premium 1.3343 Steel” and is alloyed with high contents of W and Mo in addition to the contents of alloy elements provided for 1.3343 steel. According to a commercial composition, a premium 1.3343 steel consists of, in wt. %, 0.80-0.88% C, 0.40% Mn, 0.45% Si, 3.80-4.50% Cr, 1.70-2.10% V, 5.90-6.70% W, 4.70-5.20% W, and the balance Fe and other technically unavoidable impurities. The high W and Mo contents ensure the formation of M2C and MeC type eutectic carbides. As a result of its range of properties, the steel “M2” is suitable for the manufacture of tools for machining metals or tools that are subjected to high abrasive loads at elevated temperatures during use.

Practical experience shows that, in the processing of steel powders which consist of the tool steels explained above, cold crack formation occurs when they are processed by means of L-PBF or LMD. The formation of cold cracks can be ascribed to the formation of martensite from the supercooled residual austenite matrix, and the subsequent strong increase of residual tensile stresses as a result of the low plasticity of the martensite. In order to remedy this problem, in several works a preheating has been proposed of at least the parts of the machine that are used for the respective additive manufacturing method that come directly into contact with the component to be additively manufactured. It is also known to keep the entire installation space of the machine in which the construction of the component to be formed occurs at an elevated preheating temperature. If the preheating temperature is above the martensite start temperature, that is to say the temperature point below which martensite forms, the martensite formation during the construction of the component to be formed can be avoided due to the resultant heat input and a process control at elevated temperature. However, the risk of crack formation can also be reduced with preheating temperatures below the martensite start temperature, since the material which is additively constructed to form the component cools down more slowly, and thus on the one hand has more time to reduce stresses via plastic flowing at elevated temperature and, on the other hand, phase fields which have a greater toughness and a greater plastic deformation capability can be passed through due to the slower cooling.

However, the preheating results in an increased oxidation of the powder bed that is not re-melted in the L-PBF process, which limits its recyclability. In addition, the preheating can lead to a coarsening of the structure, with the result that the fundamentally achievable fine-cellular structural formation of the component, and its associated increase in strength, are not achieved. For reasons of resource efficiency (powder re-use), and with regard to achieving the good mechanical properties, it is therefore basically sought to process materials of the type discussed here without additional heating.

### SUMMARY OF THE INVENTION

Against the background of the prior art explained in the preceding, the object of the invention is therefore to provide a steel material suitable for use in an additive manufacturing method, which steel material makes it possible to form components which are low in defects, residual stress, and tension, via additive manufacturing, without pre-heating or post-heating being necessary for this purpose.

The invention has achieved this object via the steel material as described herein.

Advantageous embodiments of the invention are specified in the dependent claims and are explained in detail below, as is the general inventive concept.

A steel material according to the invention for forming components via additive manufacturing accordingly consists of a steel with the following composition:

C: 0.28-0.65 wt. %,

Co: 10.0 wt. %,

Cr: 3.5-12.5 wt. %,

optionally Mo: 0.5-12.5 wt. %
wherein the sum of the contents of Cr and Mo is 4-16 wt. %,
wherein the Ni equivalent Ni_eq, calculated according to the formula
Ni_eq [wt. %]=30% C+% Ni+0.5% Mn
with % C: respective C content in wt. %,
   % Ni: respective Ni content in wt. %,
   % Mn: respective Mn content in wt. %,
   fulfills the following condition (1):
(1) 10 wt. %≤Ni_eq≤20 wt. %,
and, alongside C, optionally respectively up to 9 wt. % Mn and/or up to 4.5 wt. % Ni are present as necessary in the steel to fulfill condition (1),
wherein the Cr equivalent Cr_eq, calculated according to the formula
Cr_eq [wt]=% Cr+% Mo+1.5% Si+0.5% Nb+2% XX
with % Cr: respective Cr content in wt. %,
   % Mo: respective Mo content in wt. %,
   % Si: respective Si content in wt. %,
   % Nb: respective Nb content in wt. %,
   % XX: the respective sum of the contents of at least one element of the group
      “Sc, Y, Ti, Zr, Hf, V, Ta”, in wt. %,
fulfills the following condition (2):
(2) 4 wt. % Cr_eq 16 wt. %
and, alongside Cr and the optionally present content of Mo, optionally respectively additionally up to 2 wt. % Si, up to 2 wt. % Nb, and/or at least one monocarbide forming element of the group “Sc, Y, Ti, Zr, Hf, V, Ta” are present as necessary in the steel to fulfill condition (2), wherein the mass fraction of the elements of this group is in total at most equal to the maximum mass fraction of 2%, which Ti must not exceed if Ti is the only element selected from the group consisting of “Sc, Y, Ti, Zr, Hf, V, Ta”,
and wherein the rest of the steel which is not accounted for by the contents of the elements enumerated above consists of iron and technically unavoidable impurities, the total content of which is 0.5% and among which are 0.025% P and 0.025% S.

The invention thus provides a carbon-martensitically hardenable starting material based on Fe which is alloyed with molybdenum (“Mo”) and chromium (“Cr”) and can be constructed with the components by means of layered compaction or in the form of a green compact, and can be compacted with an energy source (for example laser, electron beam, arc, flame, induction, thermal radiation).

### BRIEF DESCRIPTION OF THE DRAWINGS

In the following explanations, reference is made to accompanying Figures, of which

FIG. 1 shows a diagram in which the development of the residual stress GE that arises upon processing martensitically hardening steels in the L-PBF method is plotted over the temperature T;

FIG. 2 shows a diagram in which the residual austenite content RA is plotted over the martensite start temperature Ms;

FIG. 3 shows a diagram in which the residual stresses GE which arise for various steel material samples given processing in the L-PBF method are plotted over the residual austenite content;

FIG. 4 shows a diagram, in which the nuclear porosity (without taking into account contour binding errors) of the model alloy processed by means of L-PBF is plotted as a function of the exposure time for samples produced and created in accordance with the invention;

FIG. 5 shows a diagram in which hardening-tempering curves determined for a steel material processed by means of L-PBF in accordance with the invention are reproduced.

### DESCRIPTION OF THE INVENTION

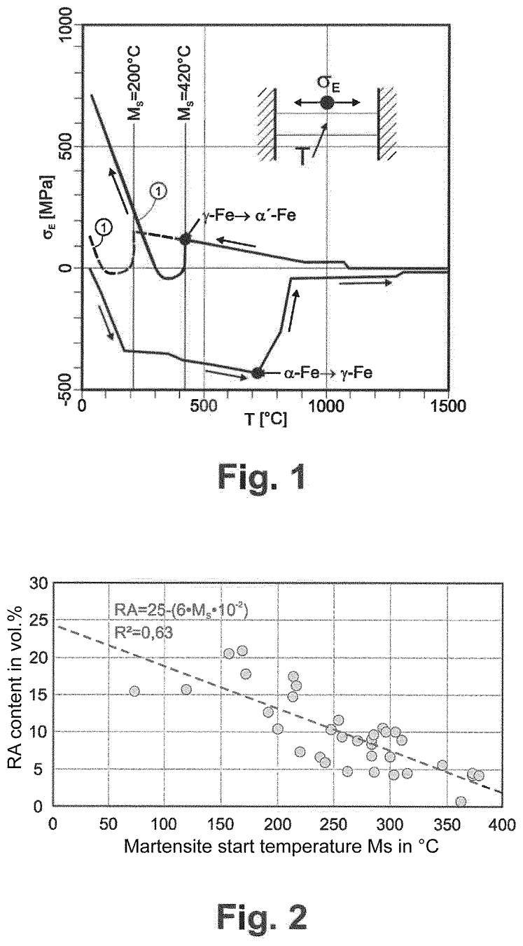

The alloy of the steel of a steel material according to the invention is adjusted in such a manner that the martensite start temperature “Ms” of a steel material according to the invention and, associated therewith, what is known as the “transformation-induced plasticity” is shifted in the direction of lower temperatures. Thus, the minimum of the curve (1) shown in FIG. 1 should be at room temperature “RT” in the best case,

as indicated in FIG. 1 by the dashed variant of the curve (1). With decreasing Ms temperature, the temperature at which the martensite formation is concluded (“martensite finish”) also falls below RT, so that converted austenite, what is known as residual austenite (“RA”), increasingly remains in the structure. The Ms temperature can be calculated as follows according to the approach by Andrews, published in K. W. Andrews: Empirical Formulae for the Calculation of Some Transformation Temperatures. In: JISI. Vol 302, 1965, pp. 721-727

Ms[° C.]=M_{S.0}−Σf_{leg}(Ma-%)_{leg}

with MS,0=539° C.

f_{leg}(C)=423

f_{leg}(Mn)=30.4

f_{leg}(Cr)=12.1

f_{leg}(Mo)=7.5

f_{leg}(Ni)=17.7

(Ma-%)_{leg}: respective content of C, Mn, Cr, Mo, Ni

The relationship between RA and Ms can be calculated as follows via the equation of Koistinen and Marburger, published in D. P. Koistinen, R. E. Marburger: A General Equation Prescribing the Extent of the Austenite-Martensite-Transformation in Pure Iran Carbon-Alloys and Plain Carbon Steels. In: Acta Metallurgica. 7, 1959, pp. 59-60

### RA=exp[-B(Ms-TU)];

with B(20° C.)=1.1×10⁻²×1/° C.;
TU: temperature, below the martensite start temperature Ms, to which the respective considered steel sample is cooled (“supercooling temperature”)

Here the invention has reduced the Ms temperature, via alloy-engineering measures, in such a manner that a stress neutrality in the component formed by L-PBF is achieved due to the transformation-induced plasticity.

The correlation between the martensite start temperature Ms, the content of residual austenite RA, and the residual stress GE can be comprehended using FIGS. 2 and 3.

In FIG. 2, the relationship of RA content and Ms temperature is shown. A linear approximation curve (“fit”) results in which the RA content decreases with increasing Ms temperature. From FIG. 3, it also results that the residual stresses GE decrease with increasing RA content, so that stress neutrality is present on average upon reaching an RA limit content of 14 vol. %. Thereby also plotted in FIG. 3 are the RA content and the level of the residual stresses which arise upon processing a powder whose particles consist of the austenitic steel known under the name 316L (Cr: 17.00-19.00%, Ni: 13.00-15.00%, Mo:≤2.25-3.0%, C:≤0.030%, Mn:≤2.00%, Cu≤0.50%, P:≤0.025%, Si:≤0.75%, S:≤0.010%, N:≤0.10%, remainder Fe, data in wt. %, see material data sheet EOS StainlessSteel 316L, published by EOS GmbH, Krallingen, DE, 5.2014, https://www.eos.info/de/additive-fertig u ng/3d-druck-metall/eos-metall-werkstoffe-dmIs/edelstahl).

The alloy of a steel material according to the invention is thus designed in such a manner that, when a component is formed from it via an additive manufacturing method, a residual austenite fraction RA of at least 10 vol. %, in particular at least 15 vol. %, materializes in the obtained component. FIG. 2 shows in this regard that such RA contents result at a martensite start temperature Ms of less than 260° C.

The martensite start temperature Ms, and thus the RA content, can be adjusted in a targeted manner via the chemical composition. In addition, the influences of the individual alloy elements on the residual austenite content RA can be estimated by the Ni equivalent and the Cr equivalent.

The determination of the alloy of the steel material according to the invention accordingly took place under consideration of the effect that the individual alloy elements have on the austenite (RA) and ferrite phases contained in the structure of a steel produced from the steel material according to the invention via additive manufacturing. The elements Ni, Co, C, Mn, and N stabilize the austenite phase, in contrast to which the carbide formers of the 3 to 6. subgroup elements and additionally Si stabilize the ferrite phase. The stabilizing effect that emerges from each alloy element can be described via the Cr equivalent “Cr_eq” and the Ni equivalent “Ni_eq”, which can be calculated according to Schaeffler, published in P. Guiraldenq, O. H. Duparc: The genesis of the Schaeffler diagram in the history of stainless steel, In: Metal. Res. Technol. 114, 613, 2017, pp. 1-9

Proceeding from the findings explained above, the invention has derived the following boundary conditions for Ni_eq and Cr_eq:

The Ni equivalent Ni_eq should be at least 10 wt. % and at most 20 wt. % (10 wt. % Ni_eq 20 wt. %).

The Cr equivalent Cr_e q should be at least 4 wt. % and at most 16 wt. % (4 wt. % Cr_eq 16 wt. %).

Via the tuning according to the invention of the Ni equivalent and the Cr equivalent of a steel material according to the invention, it is ensured that components that are produced from steel material according to the invention are crack-free and have only minimized thermally induced residual stresses, without additional technical measures, such as preheating or thermal after-treatment, needing to be implemented for this purpose.

The Ni equivalent of materials according to the invention is in the range of 10-20 wt. %. Materials alloyed in accordance with the invention, whose Ni equivalents are 12-20 wt. %, in particular at least 12.00 wt. % or more than 12 wt. %, have thereby proven to be particularly suitable with respect to the property profile sought in accordance with the invention, wherein here the Ni equivalent is preferably limited to at most 20.00 wt. %, in particular <20 wt. %.

The Cr equivalent of materials according to the invention is 4−16 wt. %, wherein Cr equivalents of at least 5.50 wt. %, in particular more than 5.5 wt. % or at least 5.70 wt. %, have proven to be particularly advantageous.

Optimized properties of a steel material according to the invention can thereby be achieved in that the sum of the Cr and Ni equivalents is 22.5-30 wt. %, in particular at least 23.00 wt. %. The effects sought by the invention can thereby be achieved in particular when the sum of the Cr and Ni equivalents is at least 23.5 wt. % or at least 24.00 wt. %, for example 25 wt. % or more than 25 wt. %.

The contents of the individual alloy elements are thereby defined as follows:

Carbon (“C”) is contained in the steel material according to the invention in contents of from 0.28 wt. % to 0.65 wt. % in order to achieve the carbon-martensitic conversion during the material processing. For this purpose, at least 0.28 wt. % C is required, wherein this effect can be achieved particularly reliably given C contents of at least 0.45 wt. %. C contents of more than 0.65 wt. % would lead to the formation of an excessively high residual austenite content, with which it would not be possible to realize the targeted tribo-mechanical properties. In addition, given excessively high C contents, the martensite start temperature Ms would be lowered in such a manner that, due to the transformation-induced plasticity, the effect of reducing the residual stress-reducing occurs only at temperatures below room temperature, and the effects utilized by the invention would not be effective. Such disadvantageous effects of excessively high C contents can, if necessary, be particularly reliably avoided in the material according to the invention in that the C content is limited to at most 0.60 wt. %. An embodiment of the invention that is particularly advantageous in practice therefore provides that the C content of a steel material according to the invention is 0.40-0.60 wt. %.

Chromium (“Cr”) is present in a steel material according to the invention in contents of from 3.5 wt. % to 12 wt. %.

Molybdenum (“Mo”) can optionally be present in the steel material according to the invention in contents of from 0.5 wt. % to 12.5 wt. %.

Given Cr contents of at least 3.5 wt. %, molybdenum can substitute chromium in a ratio of 1:1. In the event that Cr is present in a content of at least 3.5% and Mo is present in a content of at least 0.5 wt. % at the same time, Mo and Cr thus make the same contribution to the setting of the Cr equivalent Cr_eq.

The Cr content and the optional Mo content of the steel of a steel material according to the invention are set such that the Cr equivalent is stabilized in the range specified in accordance with the invention and in this way, with simultaneous consideration of the specifications prescribed in accordance with the invention for the Ni equivalent, the martensite start temperature Ms of the steel is shifted into a temperature range ranging from 125° C. to 260° C., in particular to 200° C., and a residual austenite fraction of at least 10 vol. %, in particular at least 15 vol. %, is stabilized in the structure of the respective produced component, and the effect of the transformation-induced plasticity at room temperature maximally asserts itself.

As explained above, in accordance with the invention, the proviso that the sum of the contents of Cr and Mo is to be 4 wt. % to 16 wt. % can thereby be met in that 4.0 wt. % to 12.5 wt. % Cr are present in the steel of the steel material according to the invention when Mo is absent therein, or in that at least 3.5 wt. % Cr and at the same time at least 0.5 wt. % Mo are contained in the steel, wherein the respectively present Cr and Mo contents are adapted to one another in this event in such a manner that their sum does not exceed 16 wt. %.

The advantageous influences of the presence of Cr in the steel of the steel material according to the invention can be used particularly reliably if the contents of Cr are at least 4.5 wt. %, wherein at Cr contents of at least 5.0 wt. %, in particular at least 5.5 wt. %, the effects achieved by the presence of Cr can be used particularly reliably. By contrast, given Cr contents of more than 12.5 wt. %, an excessive segregation of Cr in the residual melt could occur, which is accompanied by increased carbide formation. The Cr content bound in carbides does not contribute to the adjustment of the transformation temperatures of the metal matrix. The positive effect of the presence of Cr in the steel material according to the invention can be used particularly reliably given contents of at least 6 wt. % Cr. Cr contents of up to 10 wt. %, in particular up to 10.00 wt. % or less than 10 wt. %, in the steel material according to the invention have proven to be particularly practical.

Contents of at least 0.75 wt. % Mo also contribute to the advantageous properties of steel materials according to the invention. Contents of more than 12.5 wt. % Mo would mean that, given a minimum content of 3.5 wt. % Cr, the sum of the contents of Cr and Mo would exceed the upper limit of 16.0 wt. %. With such high total contents of Cr and Mo, no further increases in the effect of these elements would be achieved. The effects achieved by the presence of Mo in the steel material according to the invention can be used particularly effectively given Mo contents of up to 8 wt. %, in particular up to 4 wt. %.

The further alloy constituents manganese (“Mn”), nickel (“Ni”), silicon (“Si”), niobium (“Nb”), as well as titanium (“Ti”), scandium (“Sc”), yttrium (“Y”), zirconium (“Zr”), hafnium (“Hf”), vanadium (“V”), or tantalum (“Ta”) can optionally be respectively present in the steel of a steel material according to the invention in order to adjust the nickel equivalent Ni_eq and the Cr equivalent Cr_eq according to the provisions of the invention. Mn and Ni are the steel thereby serve to adjust the Ni equivalent Ni_eq as necessary. By contrast, Si, Nb, Ti, Sc, Y, Zr, Hf, V, and Ta can be provided in the steel of the steel material according to the invention in order to bring the Cr equivalent into the range according to the invention.

Since the C content is included in the calculation of the Ni equivalent Ni_eq with a factor of 30, an Ni equivalent Ni_eq of at least 10.0 wt. % already results given C contents of more than 0.33 wt. %. The requirement placed, in accordance with the invention, on the value of the nickel equivalent Ni_eq can thus already be fulfilled if C is present alone in sufficiently high contents. However, the presence of Ni in the steel can also have positive influences on the properties of a steel material according to the invention, such as an increase in toughness, independently of the setting of the Ni equivalent Ni_eq. If this effect is to be utilized, at least 0.25 wt. % Ni, in particular at least 0.5 wt. % Ni, can be provided for this purpose. However, the Ni content should not exceed 4.5 wt. %, in particular 3.0 wt. %, in order to avoid an excessively strong increase in the Ni equivalent. Ni contents of 0.75-1.25 wt. % in the steel material according to the invention have been found to be particularly practical.

Due to its comparable effect, contents of Mn in the steel alloyed in accordance with the invention can substitute contents of Ni in a ratio of 2:1, insofar as is necessary. Thus, for example, 1 wt. % Ni can be replaced by 2 wt. %

Mn. However, the Mn content should remain limited to at most 9 wt. %, in particular at most 7 wt. %, in order to avoid an excessively large increase in the Ni equivalent. The effect of Mn can already be utilized given contents of at least 0.25 wt. % Mn, wherein Mn contents of at least 0.5 wt. % or at least 1.0 wt. %, in particular at least 2 wt. %, have been found to be advantageous. According to a particularly practical embodiment, a steel material according to the invention accordingly contains 2-3 wt. % Mn.

Silicon, “Si”, has a comparably strong effect on the value of the Cr equivalent and can be added to the steel of a steel material according to the invention if it is required for deoxidation during the steel production. In the event that the steel material according to the invention is to be provided in powder form, Si contents of at least 0.15 wt. %, in particular 0.75 wt. %, can be used to set a melt viscosity that is advantageous for the atomization of the melt to form powder particles. However, excessively high contents of Si can impair the mechanical properties of a component produced from steel according to the invention. Therefore, the Si content is limited to at most 2 wt. %. The positive influences of Si given contents of at most 1.25 wt. % can be utilized particularly effectively.

To set the Cr equivalent according to requirement of the invention, a monocarbide-forming element or a plurality of monocarbide-forming elements of the group “Sc, Y, Ti, Zr, Hf, V, Ta” can optionally also be used. Of these elements, Ti is particularly suitable for the purposes of the invention; it is preferably used as the only one of the monocarbide-forming elements of this group in the steel according to the invention, and can then be present in contents of up to 2 wt. %.

The other elements of the group “Sc, Y, Ti, Zr, Hf, V, Ta” can be added to the steel in combination or as a substitute for Ti. However, the content of the appertaining elements is respectively set such that the total content of the elements of the group “Sc, Y, Ti, Zr, Hf, V, Ta” does not exceed the upper limit of the content that is applicable to Ti alone. This means that the mass fraction of the contents of the respective elements of the group “Sc, Y, Ti, Zr, Hf, V, Ta” present in the steel is, according to the invention, not intended to be greater in total than the mass fraction of 2%, which is the maximum permitted for Ti when, of the elements of the group “Sc, Y, Ti, Zr, Hf, V, Ta”, only Ti is present in the steel. Accordingly, in the event that the element in question is to be added alone, the maximum permissible Sc content is calculated as 47.867/44.956×2 wt. %=2.13 wt. %; the maximum permissible content of Y is calculated as 47.867/88.906×2 wt. %=1.08 wt. %; the maximum permissible content of Zr is calculated as 47.867/91.224×2 wt. %=1.05 wt. %; the maximum permissible content of Hf is calculated as 47.867/178.49×2 wt. %=0.54 wt. %; the maximum permissible content of V is calculated as 47.867/50.942×2 wt. %=1.88 wt. %; and the maximum permissible content of Ta is calculated as 47.867/180.95×2 wt. %=0.53 wt. %. In the event that two or more elements of the group “Sc, Y, Ti, Zr, Hf, V, Ta” of the monocarbide-forming elements are to be added to the steel of a steel material according to the invention, the contents thereof are to be adjusted accordingly in such a manner that their mass fraction in total is at most equal to the mass fraction that assumes 2 wt. % Ti if Ti alone has been added. For example, instead of 2% Ti, up to 0.94 wt. % V in combination with up to 0.5 wt. % Zr could also be added to the steel.

Cobalt (“Co”) can optionally be added to the steel of a steel material according to the invention in order to promote the development of the secondary hardening maximum in the direction of higher annealing temperatures, and the increase in the solidus temperature, and thus concurrently the increase in the solution state, via higher hardening temperatures.

The remainder of the steel of a steel material according to the invention, which is respectively not accounted for by the contents of the alloy elements added by alloying in accordance with the invention in the manner explained above, is filled by iron and technically unavoidable impurities whose content in total may be at most 0.5 wt. % and which include up to 0.025 wt. % phosphorus (“F”) and up to 0.025 wt. % sulfur (“S”). Included among the impurities are thereby, in particular, all elements of the periodic table not enumerated here which are not added in a targeted manner to the steel, but can unavoidably enter into the steel due to the processing of recycling material or due to the respective methods used in the steel production and processing. In any event, the contents of these elements in the steel of a steel material according to the invention are adjusted to be so small that they are regarded as not present in the technical sense because they have no influence on the properties of the steel material according to the invention. For example, these typically also include N contents of less than 0.1% N. The contents of impurities are thereby preferably also to be limited in such a manner that their sum is ≤0.3 wt. %, in particular ≤0.15 wt. %, wherein impurities whose contents in total are at most 0.05 wt. % have proven to be particularly advantageous as regards the desired work result.

According to a variant of the invention that is particularly important in practical terms, the steel material according to the invention is provided as a steel powder which is produced in a conventional manner, for example, by atomizing a melt alloyed in accordance with the invention. The grain sizes of the steel particles of a powder alloyed in accordance with the invention are typically 15-180 μm.

On account of its particular properties, steel powder alloyed in accordance with the invention is suitable in particular for processing by means of the “L-PBF” or “LMD” additive manufacturing method. For the L-PBF method, in particular steel powders with a particle grain size of 15-63 μm are suitable, whereas powder particles with a particle size of 63-180 μm are suitable for the LMD method. If necessary, the particles of the corresponding grain size are selected from the commercially available powder particles in a conventional manner by screening and/or sifting. Steel powder with a bulk density of 3.75 g/cm³ to 5.75 g/cm³, determined according to DIN EN ISO 3923-1; a tap density of 4.25 g/cm³ to 6.25 g/cm³, determined according to DIN EN ISO 3953; and a flow behavior of less than 30 sec/50 g, determined according to DIN EN ISO 4490, has been found to be particularly suitable for processing in such methods.

As an alternative to a processing as a powder, the steel material according to the invention can also be provided in wire form. In this form, the steel material according to the invention is particularly suitable for processing in the WAAM method or comparable additive manufacturing methods based on the principle of deposition welding.

It is also possible to provide the steel material in the form of a hollow body which is filled with a steel powder formed in accordance with the invention. Such a hollow body can typically be a filler wire or the like. It is thereby conceivable to fill the respective hollow body, such as a filler wire or a tube, with the individual elements of the alloy of a steel material according to the invention in pure form, wherein the mass fractions of the appertaining elements at the filling correspond to their contents in the alloy of a steel material according to the invention, taking into account the alloy and the mass of the material of which the hollow body consists. From the hollow body thus filled, the alloy of the steel material according to the invention is formed in situ, in the effective range of the respective heat source that is used, in the course of the melting taking place in the respective additive manufacturing method.

Independently of in which of the dosage forms explained above (powder, wire, hollow body with filling) the steel material according to the invention is used, a starting material is available with it, which starting material is optimally suitable for the production of components via additive manufacturing. In practice, by using a steel material consisting of steel alloyed in accordance with the invention, the invention can thus be used for the additive manufacturing of components. The steel material according to the invention is thereby particularly suitable for use in an L-PBF or LMD or WAAM method.

Due to its property combination, steel material according to the invention can thereby be used, in particular via powder- or wire-based additive manufacturing, to produce components or tools which are subjected to high mechanical or tribological loads and which have an optimal nature, without the use of preheating strategies and the like being required for this purpose.

The components produced from steel material according to the invention are thereby distinguished by residual austenite contents of typically at least 10 vol. %, in particular at least 15 vol. %.

The invention is explained in more detail below with reference to exemplary embodiments.

To test the invention, a molten mass was melted whose composition and whose Cr equivalent Cr_eq and Ni equivalent Ni_eq, calculated according to the formulae explained above, are indicated in Table 1.

The molten mass had been atomized in a conventional manner via gas atomization to form a steel powder, from which the particles which have a grain size of 10-63 μm, suitable for processing in the L-PBF method, were then selected by screening and sifting.

The steel powder obtained in this manner was processed into test pieces using an L-PBF plant offered under the name “SLM 100” by the company Realizer, using the process parameters listed in Table 2.

In the processing of the powder, no build plate pre-heating, as is commonly used in the processing of martensitically hardenable tool steels, was used to counteract the cold crack formation. In this way, it could be checked whether the alloy can be processed without defects without the use of a preheating of the substrate plate.

To assess the general processability of the alloy by means of L-PBF, metallographic microsections of the manufactured samples were produced and inspected with respect to porosity and crack density.

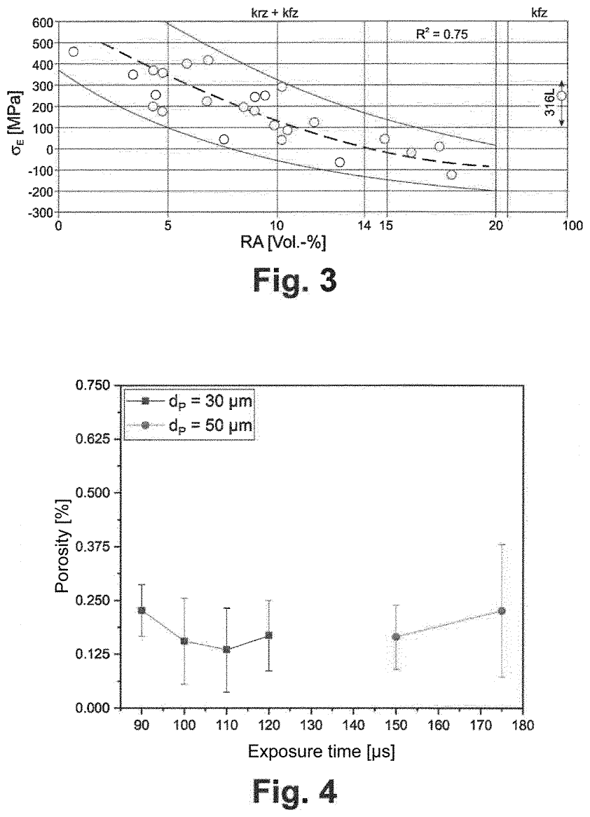

FIG. 4 shows the nuclear porosity values of the samples produced by L-PBF (porosity in the hatch region without consideration of the contour region), determined by means of quantitative image analysis. It can be seen that high sample densities in the hatch region can be achieved with all selected process parameters. This indicates a comparatively wide process window with which the alloy can be processed with few pores. Moreover, only a very small number of cold cracks could be detected in the structure of the alloy produced by L-PBF. The samples were to be assessed as free of cracks to the greatest possible extent. An exposure time of 110 μs with a pixel pitch of 30 μm was evaluated as an optimal parameter. Overall, it is to be noted that the model alloy derived from preliminary tests can be processed without defects by means of L-PBF without the preheating of the substrate plate.

To assess the basic suitability of the alloy as a material for tool applications or otherwise wear-afflicted components, the hardening-tempering behavior of the alloy processed by means of L-PBF was examined. The examined samples were produced with the parameter set identified as being well-suited (exposure time 110 μs, pixel pitch 30 μm).

Within the scope of the tests, scanning electron micrographs of the etched structure of the samples in the respective heat treatment states were prepared, and the Vickers hardness was determined. The tests took place on samples in the heat treatment states reproduced in Table 3.

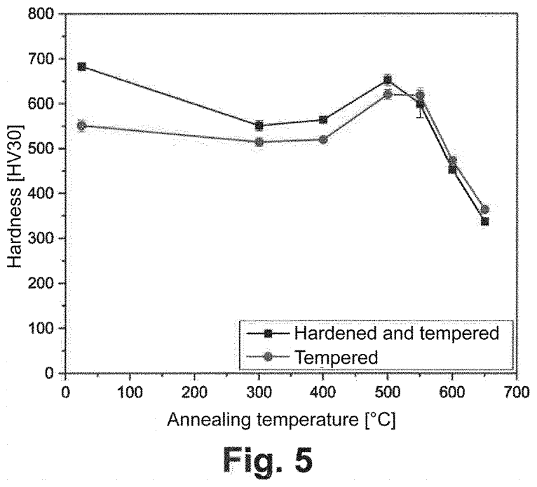

The results of the hardening-tempering tests are shown in FIG. 5. A typical hardening-tempering behavior for secondary-hardenable martensitic tool steels can be seen. A high starting hardness and a pronounced secondary hardening maximum are adjustable via suitable heat treatment, and demonstrate that steel materials according to the invention are suitable in particular for the production of tools via additive manufacturing.

TABLE 1
Specifications in wt. %, remainder iron and unavoidable impurities

| c | Mo | Cr | Mn | Ni | Si | Cr_eq | Ni_eq |
|---|---|---|---|---|---|---|---|
| 0.44 | 2.7 | 6.3 | 2.4 | 1.0 | 0.9 | 10.27 | 15.51 |

TABLE 2
Overview of the process parameters used for compaction
of the model alloy. Effective laser power = 77.4
W; layer thickness = 30 μm; no build plate pre-heating.

| Pixel pitch in μm | Exposure time in μs | Energy input in J/m |
|---|---|---|
| 30 | 80 | 206.4 |
| | 90 | 232.2 |
| | 100 | 258 |
| | 110 | 283.8 |
| | 150 | 387 |
| | 175 | 451.5 |
| 50 | 150 | 232.2 |
| | 175 | 270.9 |

TABLE 3

| Heat | Heat treatment parameters | |
|---|---|---|
| treatment state | Hardening | Tempering |
| Tempered | | Duration: 2 × 2 h at 650° C. |
| | | cooling to room temperature in air |
| Hardened | T_{Aust} = 1060° C. | Duration: 2 × 2 h at 650° C. |
| and tempered | t_{Aust} = 30 min | cooling to room temperature in air |
| | Oil | |

1. A steel material for forming components via additive manufacturing, consisting of steel with the following composition:
C: 0.28-0.65 wt. %
Co: ≤10.0 wt. %,
Cr: 3.5-12.5 wt. %,
optionally Mo: 0.5-12.5 wt. %
wherein the sum of the contents of Cr and Mo is 4-16 wt. %,
wherein the Ni equivalent Ni_eq, calculated according to the formula
Ni_eq [wt. %]=30% C+% Ni+0.5% Mn
with % C: respective C content in wt. %,
% Ni: respective Ni content in wt. %,
% Mn: respective Mn content in wt. %,
fulfills the following condition (1):
(1) 10 wt. %≤Ni_eq≤20 wt. %,
and, alongside C, optionally respectively up to 9 wt. % Mn and/or up to 4.5 wt. % Ni
are present as necessary in the steel to fulfill condition (1),
wherein the Cr equivalent Cr_eq, calculated according to the formula
Cr_eq [wt]=% Cr+% Mo+1.5% Si+0.5% Nb+2% XX
with % Cr: respective Cr content in wt. %,
% Mo: respective Mo content in wt. %,
% Si: respective Si content in wt. %,
% Nb: respective Nb content in wt. %,
% XX: the respective sum of the contents of at least one element of the group
“Sc, Y, Ti, Zr, Hf, V, Ta”, in wt. %, fulfills the following condition (2):
(2) 4 wt. %≤Cr_eq≤16 wt. %
and, alongside Cr and the optionally present content of Mo, optionally respectively additionally up to 2 wt. % Si, up to 2 wt. % Nb, and/or at least one monocarbide forming element of the group “Sc, Y, Ti, Zr, Hf, V, Ta” are present as necessary in the steel to fulfill condition (2), wherein the mass fraction of the elements of this group is in total at most equal to the maximum mass fraction of 2%, which Ti must not exceed if Ti is the only element selected from the group consisting of “Sc, Y, Ti, Zr, Hf, V, Ta”,
and wherein the rest of the steel which is not accounted for by the contents of the elements enumerated above consists of iron and technically unavoidable impurities, the total content of which is ≤0.5% and among which are ≤0.025% P and ≤0.025% S.

2. The steel material according to claim 1, wherein for the sum Cr_eq+Ni_eq formed from the Cr equivalent and Ni equivalent, the following applies
22.5 wt. %≤Cr_eq+Ni_eq≤30 wt. %.

3. The steel material according to claim 1, wherein its C content is 0.40-0.60 wt. %.

4. The steel material according to claim 1, wherein its Cr content is 5.50-10 wt. %.

5. The steel material according to claim 1, wherein its Mo content is 0.75-4 wt. %.

6. The steel material according to claim 1, wherein its Ni content is 0.75-1.25 wt. %.

7. The steel material according to claim 1, wherein its Mn content is 2-3 wt. %.

8. The steel material according to claim 1, wherein its Si content is 0.75-1.25 wt. %.

9. The steel material according to claim 1, wherein of the elements of the group “Sc, Y, Ti, Zr, Hf, V, Ta”, if required, Ti alone is present at a content of up to 2 wt. % in the steel of the steel material.

10. The steel material according to claim 1, wherein its martensite starting temperature is Ms 125-260° C.

11. The steel material according to claim 1, wherein it is a steel powder.

12. The steel material according to claim 11, wherein the particles of the steel powder have an average grain size of 15-180 μm.

13. The steel material according to claim 11, wherein the steel powder has a bulk density of 3.75 g/cm³ to 5.75 g/cm³ (determined according to DIN EN ISO 3923-1).

14. The steel material according to claim 11, wherein the steel powder has a tap density of 4.25 g/cm³ to 6.25 g/cm³ (determined according to DIN EN ISO 3953).

15. The steel material according to claim 1, wherein the steel powder has a flow behavior determined in accordance with DIN EN ISO 4490 of less than 30 sec/50 g.

16. The steel material according to claim 1, wherein it is a steel wire.

17. The Steel material according to claim 1, wherein said material is formed into a hollow body filled with a steel-powder.

18. A method of producing components via additive manufacturing, wherein said method includes a step of using a steel material, formed in accordance with claim 1.

19. The method of claim 18, wherein the additive manufacturing comprises a laser powder bed fusion method, a laser metal deposition method or a wire arc additive manufacturing method.

20. The method of claim 18, wherein a retained austenite content in microstructure of said components is at least 10% by volume.
